(19) United States
(12) Patent Application Publication
(10) Pub. No.: US 2010/0177734 A1
(43) Pub. Date: Jul. 15, 2010

(54) COMMUNICATION DEVICE AND RADIO COMMUNICATION METHOD

(75) Inventor: Hiroki Fujita, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/602,061

(22) PCT Filed: May 13, 2008
(86) PCT No.: PCT/JP2008/058747

§ 371 Date: Jan. 21, 2010

(30) Foreign Application Priority Data
May 29, 2007 (JP) 2007-142471

(51) Int. Cl. H04W 36/00

(52) U.S. Cl. 370/331

(57) ABSTRACT

The communication device according to the present invention comprises a packet reception unit 220 for receiving packets from an opponent communication device connected to said communication device, a jitter buffer 228 for storing the packets received by said packet reception unit 220, and a continuity recognition unit 230 for causing said communication device to recognize, when handover takes place to an original opponent communication device, that packets from the original opponent communication device stored in said jitter buffer 228 and packets received from a new opponent communication device after the handover are continuous packets in the same session (FIG. 2).

### BACKGROUND OF THE INVENTION

The present invention relates to a communication device connected to a terminal such as a mobile phone. More specifically, the present invention relates to a communication device and wireless communication method which apply a wireless communication system using conventional Integrated Service Digital Network to IP communication network.

In recent years, wireless terminals represented by mobile phones or PHS (Personal Handy Phone System) are becoming widespread and they makes voice communication and data download possible regardless of time or place. Such a wireless terminal communicates wirelessly with one of base stations located at predetermined intervals and thereby establishes a connection with a communication network. The one base station establishes communication with another base station located within communication range of a communication partner (another wireless terminal) in order to allow voice communication between the two wireless terminals. These base stations are currently connected by the Integrated Service Digital Network.

The Integrated Service Digital Network stated above is a digitally converted public telephone network. Communication can therefore be carried out at signal transfer speeds of at least 64 kbps on 1 channel and it is possible to improve the stability of voice communication between wireless terminals. However, ADSL (Asymmetric Digital Subscriber Line) which is recently becoming rapidly widespread has a transfer speed of a few Mbps to tens of Mbps and FTTH (Fiber To The Home) via optical fiber can reach transfer speeds of hundreds of Mbps. Therefore, replacing the Integrated Service Digital Network which initially had excellent transfer speeds and stability with an IP (Internet Protocol) communication network with even higher transfer speeds is also being considered for use in wireless communication systems between wireless terminals.

If VoIP (Voice over Internet Protocol) via an IP communication network or RTP (Real-Time Transport Protocol) is used instead of the Integrated Service Digital Network, it is also possible to improve transfer speed and to reduce communication occupancy time by data packetization, and because it is possible to share one digital line between a number of voice conversations it is also possible to cut the costs required for voice communication over one digital line. Thus, various technologies are being proposed for wireless communication systems which use this type of IP communication network.

For example, according to a technology proposed in Patent Documents 1 and 2, when the wireless terminal of a communication partner moves and causes handover whereby the data transmission destination changes from an original base station to a new one, the original and new ones are registered and a jitter buffering process is changed depending on whether or not transmitted data is real time traffic.

According to a technology disclosed for example in Patent Document 3, in the case handover occurs as stated above, packets which were sent before the handover i.e. change of destination base station and lost their destination are lead to a new route by a multiarmed router of the original and new base stations. Therefore, it is not necessary to send the packets back to an original transmitting router even in the case of handover.

### Patent Document 1: Japan Laid Open Patent 2002-125254

### Patent Document 2: Japan Laid Open Patent 2005-323391

### Patent Document 3: Japan Laid Open Patent 2004-015143

As stated above, although a variety of new technologies are being adopted with regards to the transmission process of packets in the case where the wireless terminal of a communication partner is handed over, existing technology is still being used with regards to the receiving process of packets in the case where the wireless terminal of a communication partner is handed over. For example, a jitter buffer is arranged in a base station to absorb the jitter of data caused by a time delay. Before the packets transmitted from another base station are transmitted to the wireless terminal which is the final destination, they are once stored in the jitter buffer of the base station. By using a jitter buffer, it is possible to prevent a break up or overlapping of voice in communication and the generation of noise.

An SSRC (Synchronization Source) identifier is attached to a packet which is transmitted. This identifier shows that the packet has passed through a base station connected to a transmitting wireless terminal. An identifier matching unit provided in a receiving base station observes the integrity of the received packet and stores the packet after the SSRC is confirmed. Therefore, when the transmitting base station is switched due to the handover, the SSRC is changed accordingly and it is no longer possible for the identifier matching unit to confirm following packets with different SSRC.

FIG. 7 is an explanation diagram for showing a storage process of packets at the time of a handover. Here, an example is given in which voice data is transmitted from a transmitting wireless terminal 10, through a base station 12A and a base station 12B, to a receiving wireless terminal 14. FIG. 7A shows a state before handover and the packets A8, A9, A10 from the base station 12A are stored in the jitter buffer 16. As is shown in FIG. 7B, when handover of the wireless terminal 10 occurs, a new packet C1 from the base station 12C is received in the base station 12B.

The base station 12B can correlate its own jitter buffer 16 with only one opponent base station and therefore the jitter buffer 16 cannot store data from a plurality of base stations at the same time. Therefore, the identifier matching unit of the base station 12B terminates a session with the original opponent base station 12A, completely disposes of the packets accumulated in the jitter buffer 16 as shown in FIG. 7B, establishes a new session with a new opponent base station 12C, sets the SSRC of the new opponent base station 12C and starts receiving the packet C1. The disposal of data takes place because insertion of data from a different session is not assumed by the RTP and therefore when an RTP process is finished there is no longer a link between the previous and present sessions and the data obtained in the previous session are no longer required. Following this, the base station 12B stores packets from the base station 12C in the jitter buffer 16 as is shown in FIG. 7C. Because this process takes place together with disposal of the packets accumulated in the jitter buffer 16, break ups in voice communication or noise would occur during phone conversations.

Thus, a technology is being examined in order to avoid such packet disposal. According to the technology, two jitter buffers are arranged and a jitter buffer in which packets are to be accumulated is switched together with the switching of the SSRC.

FIG. 8 is an explanation diagram for showing a storage process of packets at the time of a handover by two jitter buffers. In the case where handover occurs and the state changes from FIG. 8A to FIG. 8B, the packet C1 from the base station 12C is stored in a different jitter buffer which has a different SSRC reference value. In this technology, the packets previously stored in one of the jitter buffers 16 are transmitted continuously and new packets are accumulated in the other jitter buffer 18. Then, when a sufficient amount of the new packets have been accumulated in the other jitter buffer 18, the jitter buffer 16 is replaced with the jitter buffer 18 as a new one for being loaded with packets at an arbitrary timing as shown in FIG. 8C. This solution can maintain the continuity of the packets, but an increase in the number of jitter buffers, additional control circuits and costs may be necessary.

In addition, even if the above-mentioned SSRC reference value is disabled for storing packets in the same jitter buffer, there still remains the problem of discontinuity in sequence numbers or time stamps. This problem is due to the fact that even though continuity in sequence numbers or time stamps which are attached to packets sent from the same base station is secured, such a continuity is not guaranteed between a pair of different base stations, because an initial value of sequence number or time stamp is decided randomly for each base station. Each base station decides such a unique initial value of sequence number or time stamp in order to prevent the position of a sequence number or time stamp within a packet from being specified by unlawful access.

FIG. 9 is a diagram for explaining the problems involved in a storage process of sequence numbers. Here, a numerical value attached to a character within a packet indicates a sequence number. In a wireless communication system which uses an IP communication network, for example, when a packet C1 (a packet received from a new opponent base station 12C) with a discontinuous sequence number is received as in FIG. 9A, because a sequence processing unit reorders the packets within the jitter buffer in order of sequence numbers as in FIG. 9B, the new packets (C1, C2) are placed before the already existing packets (A9, A10, A11) and the original order (A9, A10, A11, C1, C2, . . . ) is broken. Therefore, the previous data can no longer be reproduced.

FIG. 10 is a diagram for explaining the problems involved in a storage process of time stamps. As is shown in FIG. 10A, the numerical value below a packet which is coming from the base stations 12A and 12C indicates a time stamp and the numerical value below the packet within the jitter buffer 16 indicates playback time. Playback time is obtained by adding an initial offset time of the packet to the time stamp. Even if a new packet C1 with a different initial time stamp (0:00) is received as in FIG. 10B, a time conversion unit adds an existing offset time (−3:00) to the time stamp (0:00) of the packet C1, as is shown in FIG. 100. Therefore, the playback time of the packet C1 shows a past time (−3:00) and the packet can no longer be played back. In the storage process of this type of time stamp, as stated above, the playback time is sometimes set in the distant past or distant future and playback becomes impossible.

The present invention attempts to solve the problems of this type of conventional wireless communication system and provide a communication device and wireless communication method which can maintain seamless packet transmission using only one existing jitter buffer without losing a packet even if the opponent base station is switched.

In order to solve the above stated problems, according to an aspect of the present invention, a communication device for performing wireless communication with a wireless terminal and for being connected by a real time data transmission protocol (RTP) via an IP communication network with a plurality of opponent communication devices comprising: a packet reception unit for receiving packets from an opponent communication device connected to said communication device; a jitter buffer for storing the packets received by said packet reception unit; and a continuity recognition unit for causing said communication device to recognize, when handover takes place to an original opponent communication device, that packets from the original opponent communication device stored in said jitter buffer before the handover and packets received from a new opponent communication device after the handover are continuous packets in the same session.

The packets from the new opponent communication device are treated as those from the original opponent communication device by causing the own-side communication device to recognize the both packets as if transmitted continuously from the same communication device. Therefore, it becomes possible to continuously store packets in the same jitter buffer without terminating a session and without disposing packets received from the original opponent communication device and already stored in the jitter buffer. Because it is possible to continuously receive packets, without losing a packet, from a plurality of opponent communication devices using the only one existing jitter buffer, it is possible to reduce costs of memory capacity and control circuits.

The communication device may further comprise an identifier matching unit for correlating and setting to the session an identifier which is the same as that attached to a packet from the original opponent communication device, and for matching the identifier with other identifiers of packets received by said packet reception unit. Said continuity recognition unit may replace the identifier correlated and set to the session with another identifier which is the same as that attached to a packet from the new opponent communication device.

As stated above, an SSRC (identifier) is attached to a packet transmitted between communication devices. The SSRC identifier shows that the packet is transmitted from the opponent communication device. By replacing the SSRC with another SSRC of a new opponent communication device, the identification matching unit recognizes the received packets as packets from the same communication device and it is possible to store the packets in the same jitter buffer without adding any special process.

The communication device may further comprise a sequence processing unit for referring to sequence numbers of packets stored in said jitter buffer and of new packets received by said packet reception unit and for reordering the new packets in the order of their sequence numbers. Said continuity recognition unit may renumber the packets from the original opponent communication device stored in said jitter buffer so that the sequence numbers of the packets from the original opponent communication device and of the packets from the new opponent communication device are continuous.

According to the above structure, it is possible to renumber the original and new packets stored in the jitter buffer so that they have continuous sequence numbers, and the following new packets with continuous numerical values can also be stored in their correct order. Therefore, it is possible to securely play back all the data in their correct order even if a packet of a random initial sequence number comes from a new opponent communication device.

The communication device may further comprise a time conversion unit for shifting the times of time stamps of packets received by said packet reception unit to the amount of an offset time, for converting the shifted times to playback times in the session and for storing in said jitter buffer the converted playback times in connection with the packet. Said continuity recognition unit may change the offset time so that the playback times of the packets from the original opponent communication device and of the received packets are continuous.

According to the above structure, it is possible to make the playback times of the original and new packets in the jitter buffer continuous and to give appropriate playback times to the following packets. Therefore, it is possible to accurately play back all the data even if a packet of a random initial time stamp comes from a new opponent communication device.

Said continuity recognition unit may start operation when a packet from the new opponent communication device is first received by said packet reception unit.

According to the above structure, the opponent communication device is switched at the timing when the packet from the new opponent communication device is first received. By recognizing the packet from the new opponent communication device as that from the original opponent communication device at this timing as stated above, it is possible to smoothly shift to the new opponent communication device.

In order to solve the above stated problems, according to another aspect of the present invention, a wireless communication method for performing wireless communication using a wireless terminal and a communication device which is connected by wireless communication with the wireless terminal and is connected by a real time data transmission protocol (RTP) via an IP communication network with opponent communication devices comprising: a step for receiving packets from an opponent communication device connected to the communication device; and a step for causing the communication device to recognize, when handover takes place to an original opponent communication device, that packets from the original opponent communication device stored in a jitter buffer before the handover and packets received from a new opponent communication device after the handover are continuous packets in the same session; and a step for storing the received packets in the jitter buffer.

The structural elements and their explanations which correspond to the technological ideas in the communication device stated above can also be applied to the wireless communication method.

### EFFECTS OF THE INVENTION

In the communication device of the present invention as explained above, seamless packet transmission can be maintained using only one existing jitter buffer without losing a packet even if the opponent communication device is switched due to handover.

### BRIEF EXPLANATION OF THE DRAWINGS

FIG. 1 is a system block diagram for explaining a wireless communication system.

FIG. 2 is a block diagram for showing the schematic functions of a base station.

FIG. 3 is a diagram for explaining the replacement of an SSRC by a continuity recognition unit.

FIG. 4 is a diagram for explaining a change in sequence numbers by the continuity recognition unit.

FIG. 5 is a diagram for explaining a change in time stamps by the continuity recognition unit.

FIG. 6 is a sequence diagram for showing a process flow particularly at the time of a handover in the wireless communication system.

FIG. 7 is an explanation diagram for showing a storage process of packets at the time of a handover.

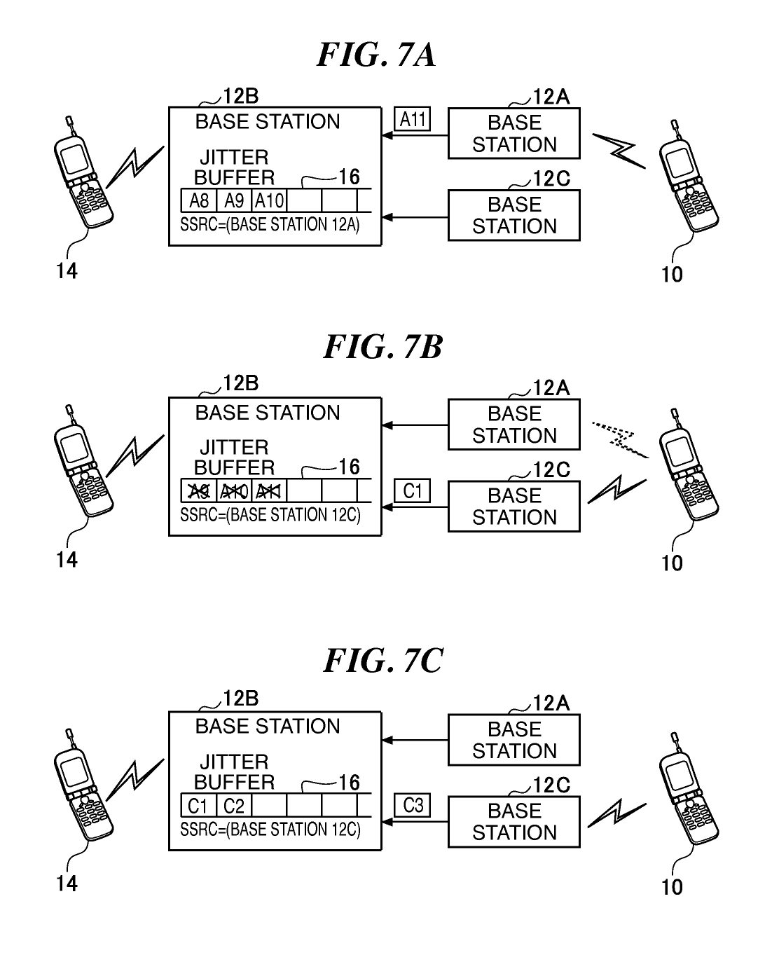

FIG. 8 is an explanation diagram for showing a storage process of packets at the time of a handover by two jitter buffers.

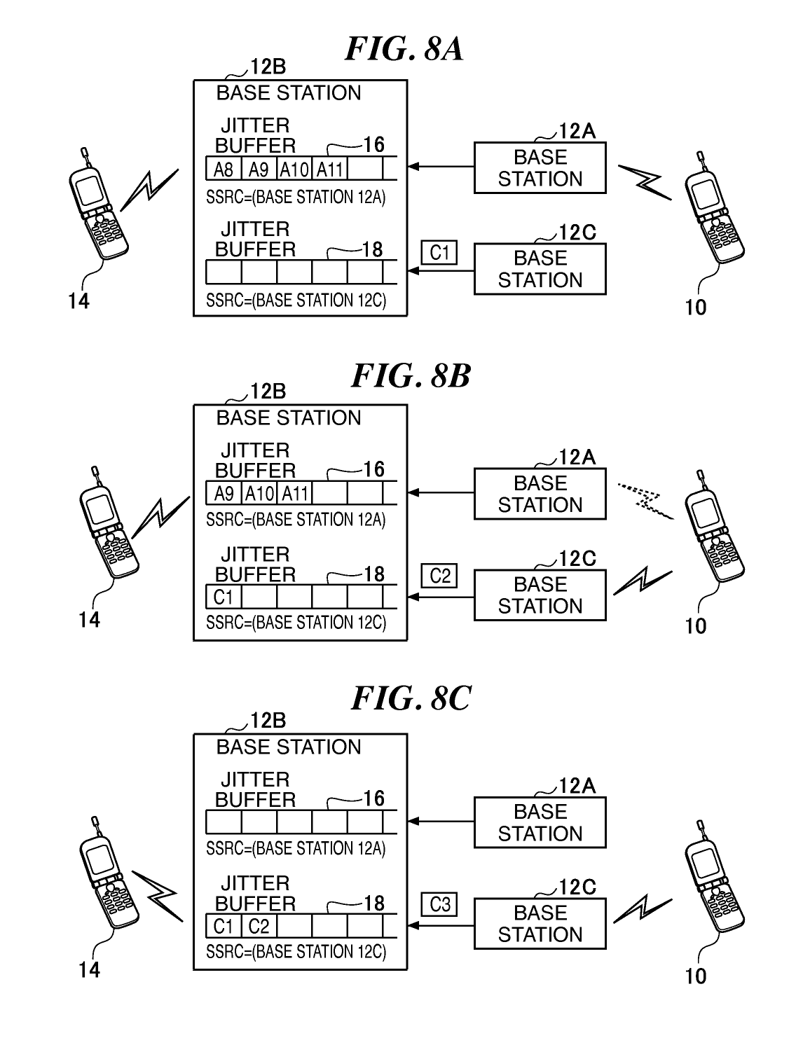

FIG. 9 is a diagram for explaining the problems involved in a storage process of sequence numbers.

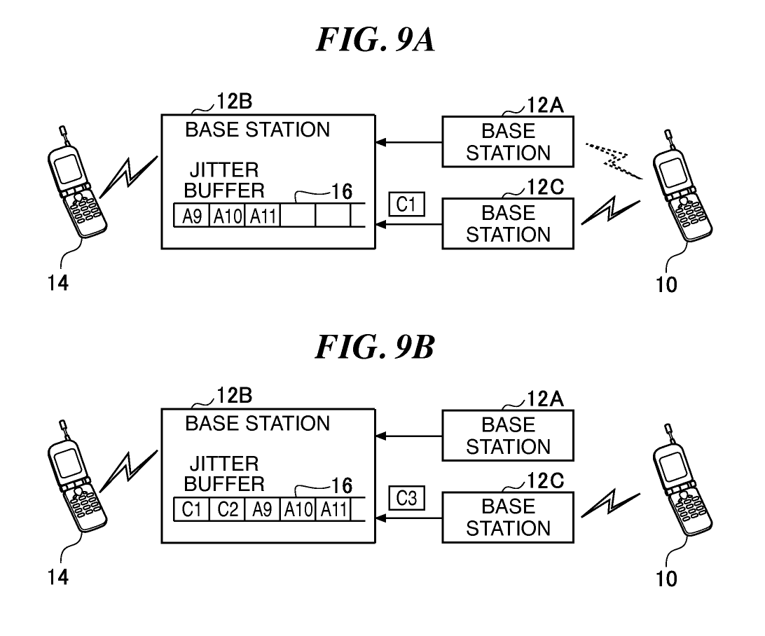

FIG. 10 is a diagram for explaining the problems involved in a storage process of time stamps.

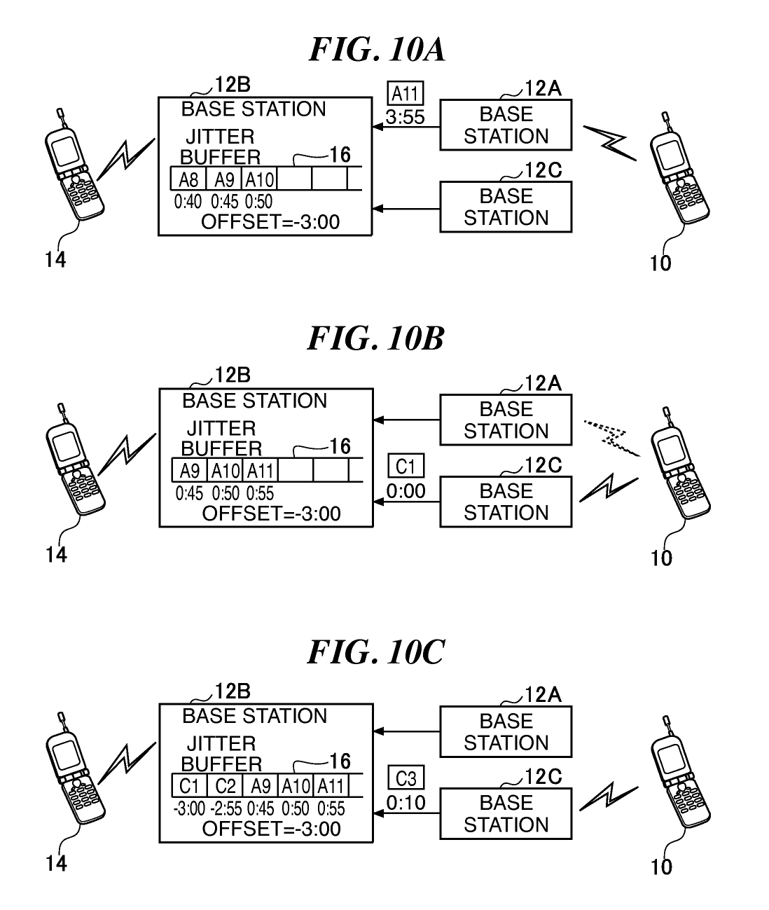

### EXPLANATION OF REFERENCE NUMERALS

120 Base Station
220 Packet Reception Unit
222 Identification Matching Unit
224 Sequence Processing Unit
226 Time Conversion Unit
228 Jitter Buffer
230 Continuity Recognition Unit

### BEST MODE FOR CARRYING OUT THE INVENTION

The best embodiments for realizing the present invention will be explained in detail below with reference to the accompanying drawings. In the present description and drawings, the structural elements which have essentially the same functional structure are indicated by the same reference numerals in order to omit overlapping explanations.

Communication between wireless terminals such as a mobile phone or PHS and an opponent terminal which is in a remote location is established using a wireless system. In the wireless system, the wireless communication is firstly established between a wireless terminal and a selected one of base stations located at predetermined intervals. Then, the selected one base station is connected with a connection selection server which performs call-setup using an Integrated Service Digital Network (hereinafter referred to simply as ISDN), and further connected via the connection selection server to an opposite base station of the communication partner. In ISDN, a communication signal between the base stations is transmitted digitally.

The present embodiment uses an IP communication network, which can reduce operational costs, instead of or in addition to the above stated ISDN in order to realize communication between communication devices such as a base station or exchange station via a Real-time data Transmission Protocol (hereinafter referred to simply as RTP), and to make seamless voice communication possible even in the case where handover is necessary. The word “handover” is referred to as switching a base station which is connected with a wireless terminal. In the embodiments below, a base station is used as an example of a communication device according to the present invention in order to simplify explanation, however, the present invention is not limitedly applied to a base station. For example, an exchange station or other electronic devices used in the selection of a communication route may be included in the communication device according to the invention.

The above stated RTP corresponds to a session layer as well as VoIP and functions as a top level protocol of UDP (User Datagram Protocol). In addition, RTP is provided with RTCP (RTp Control Protocol) as a control protocol which performs minimum delivery confirmation and observation. RTP is suitable for transferring image and voice data in real time, can packetize data to be transferred within a session in certain time units and can transfer these packets with a time stamp attached. A “session” is referred to as a unit of access to a web site, and one session corresponds to a series of processes performed during the time a user is connected to a web site.

The voice playback device in a wireless terminal which receives transferred packets, reorders the packets stored in a buffer according to sequence numbers attached to the packets and plays back the packetized voice or image data in sequence according to the play back times attached to the packets. RTP enables a packet to be played back independent of other packets. Therefore, it is possible to play back a packet regardless of a past packet which does not reach a terminal or of a missing packet whereby a part of the data is missing.

When handover takes place due to a movement of a wireless terminal which is the original transmitter of voice data, the opponent base station is switched. When the opponent base station is switched, the communication route is changed, and the SSRC (Synchronization Source) identifier for identifying an opponent base station of packets, sequence numbers which show the play back order of the packets and time stamps which show the play back timings of the packets are also changed. A jitter buffer of an own-side base station which accumulates the packets is usually correlated one to one with an opponent base station by SSRC. Therefore, a jitter buffer cannot accumulate packets with an SSRC identifier different from SSRC of the jitter buffer.

SSRC is the source of an RTP packet stream and is comprised of a random 32-bit identifier independent of a network address. Electronic devices which receive an RTP packet gather packets with reference to SSRC.

In a conventional manner, when an own-side base station receives notification that the SSRC of a packet (RTP packet) has changed, it terminates the session with an original opponent base station. The packets accumulated within the jitter buffer of the own-side base station are completely disposed of and reception of packets from a new opponent base station is restarted. In order to avoid such packet disposal, two jitter buffers can be arranged in the own-side base station and they can be switched to each other for transmitting data to a wireless terminal depending on the circumstances. However, this leads to an increase in the number of jitter buffers and an increase in the cost of additional control circuits.

The object of the present embodiment is to maintain seamless packet transmission without losing a pachet using only one existing jitter buffer, even if SSRC identifiers, sequence numbers and time stamps of transmitted packets are changed and the continuity of the packets is broken.

### (Wireless Communication System 100)

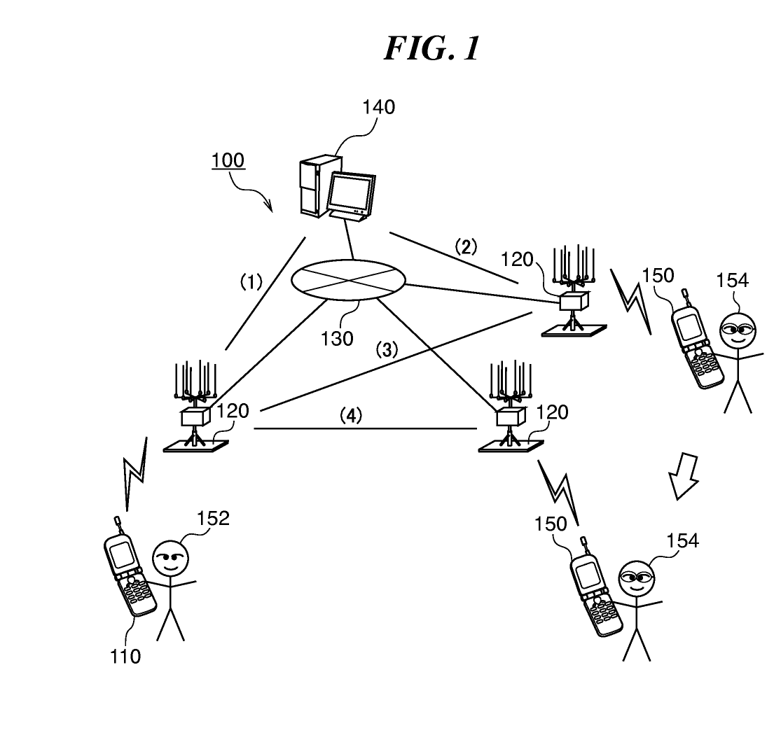

FIG. 1 is system block diagram for explaining a wireless communication system 100. The wireless communication system 100 is comprised of wireless terminal 110 owned by a user, base stations 120, an IP communication network 130 such as the internet and a connection selection server 140.

In the wireless communication 100 stated above, in the case where a user 152 attempts to call an opponent terminal 150 using the wireless terminal 110, wireless communication is established with one of the base stations 120 which is located in an area capable of wireless communication with the wireless terminal 110 of user 152, and the one of the base stations 120 requests communication connection with the opponent wireless terminal 150 to the communication selection server 140 via the IP communication network 130 as is shown by arrow (1) in FIG. 1.

Then, the connection selection server 140 sets an opponent base station 120 which is in the area capable of wireless communication with the opponent wireless terminal 150 as is shown by arrow (2) in FIG. 1 and sets the voice communication with the opponent wireless terminal 150 owned by the communication partner 154.

Then, when setting required for voice communication is completed by the opponent base station 120, the connection selection server 140 passes the voice communication process to the pair of base stations 120 as is shown by arrow (3) in FIG. 1 and the pair of base stations 120 of the user 152 and of the communication partner 154 become the main components and perform direct transmission and reception of voice signals. At this time, the connection selection server 140 shifts to a standby state in order to allot an appropriate base station 120 according to changes in the communication environment of wireless terminals 110 and 150.

If the communication partner 154 moves and continuation of communication with the opponent base station 120 becomes difficult, a new one of the base stations 120 located in the range capable of wireless communication with the moved wireless terminal 150 is selected by the connection selection server 140 and handover is initiated. Then, communication with the new one of the base stations 120 begins as is shown by arrow (4) in FIG. 1.

The structure of a base station 120 in the wireless communication system 100 is explained below and following this, a wireless communication method for performing a handover in the wireless communication system 100 is explained.

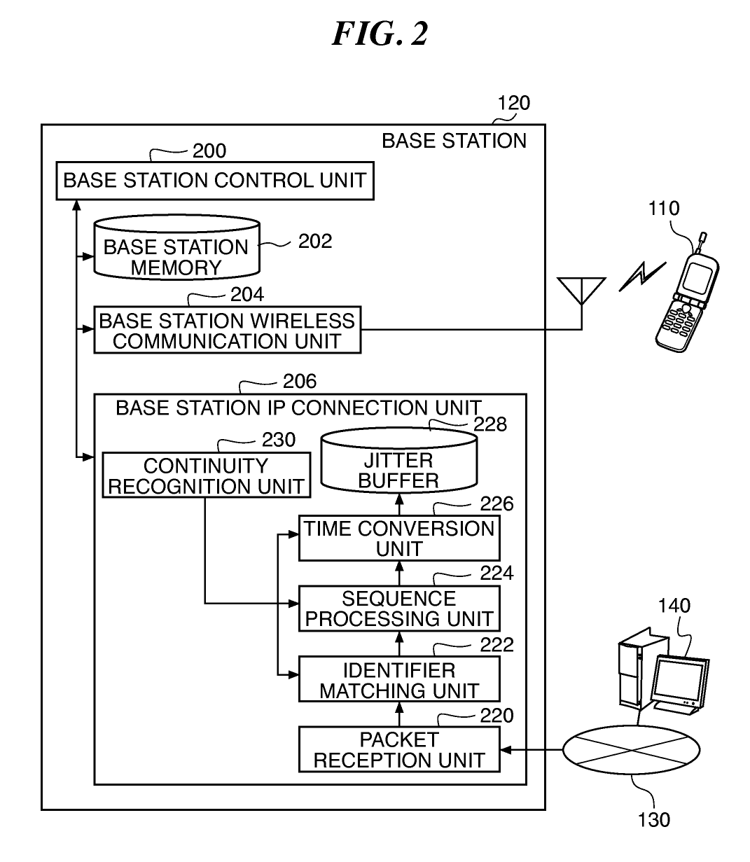

FIG. 2 is a block diagram which shows the schematic functions of the base station 120. Base station 120 is comprised of base station control unit 200, base station memory 202, base station wireless communication unit 204 and base station IP connection unit 206.

The base station control unit 200 stated above manages and controls the entire base station 120 via a semiconductor integrated circuit which includes a central processing unit. The base station control unit 200 terminates a phone call or communication between wireless terminals using a program of the base station memory 202.

The base station memory 202 stated above can be comprised of ROM, RAM, E²PROM, non-volatile RAM, a flash memory and HDD and stores programs processed by the base station control unit 200 and data transmitted and received between the wireless terminals.

The base station wireless communication unit 204 stated above performs wireless communication with the wireless terminal 110 based on a mobile telephone network. For example, the present embodiment uses a time division multiple access (TDMA) method which carries out communication so that a plurality of time slots are created by dividing frames by time at the base station 120 are allotted to respective channels.

The base station IP connection unit 206 stated above carries out transmission and reception of setting signals with the connection selection server 140 through the IP communication network 130. Before a voice signal is output to the IP communication network 130, the voice signal is converted to a digital signal, IP packetized and transmitted by the base station IP connection unit 206. In addition, a packet reception unit 220, an identifier matching unit 222, a sequence processing unit 224, a time conversion unit 226, a jitter buffer 228 and a continuity recognition unit 230 are included in the base station IP connection unit 206.

The packet reception unit 220 is adapted to receive packets from an opponent base station 120 which is connected with the own-side base station 120 shown in FIG. 2 via the IP communication network 130. In the present embodiment, the packet reception unit 220 can receive packets both from the original opponent base station 120 which is presently connected to the own-side base station 120 shown in FIG. 2 and from the new opponent base station 120 which is the destination of the handover.

The identifier matching unit 222 is adapted to set an SSRC to a session. This SSRC is the same as that attached to a packet from the original opponent base station 120. The identifier matching unit 222 is adapted to match the SSRC set to the session with that of a packet received by the packet reception unit 220. Specifically, the SSRC set to the session and the SSRC attached to the received packet are compared with each other. If they are the same, the received packet is identified as a packet from the original opponent base station 120.

The sequence processing unit 224 is adapted to refer to the sequence numbers of the packets stored in the jitter buffer 228 and of new packets received by the packet reception unit 220, and is adapted to reorder in the jitter buffer 228 the new packets in order of their sequence numbers.

The time conversion unit 226 is adapted to shift the time of a time stamp of a packet received by the packet reception unit 220 to the amount of an offset time, to covert it to a playback time in the session and to store in the jitter buffer 228 the converted playback time in connection with the packet.

The jitter buffer 228 is a buffer which absorbs arrival timing lag of a voice signal. It stores a packet which was received by the packet reception unit 220 and reception-processed as above by the identifier matching unit 222, sequence processing unit 224 and time conversion unit 226.

In the case where an original opponent base station 120 is handed over, the continuity recognition unit 230 causes the own-side base station 120 to recognize the packets from the original opponent base station 120 already stored in the jitter buffer 228 and the packets from a new opponent base station 120 of the handover destination as continuous packets in the same session.

As above, the packets from the new opponent base station 120 are treated as those from the original opponent base station 120 by causing the own-side base station to recognize the both packets as if transmitted continuously from the same base station. Therefore, it becomes possible to continuously store packets in the same jitter buffer 228 without terminating a session and without disposing packets received from the original opponent base station 120 and already stored in the jitter buffer 228. Because it is possible to continuously receive packets, without losing a packet, from a plurality of opponent communication devices using the only one existing jitter buffer 228, it is possible to reduce costs of memory capacity and control circuits.

In order for the continuity recognition unit 230 to cause the own-side base station 120 to recognize the packets from the original opponent base station 120 and those from the new opponent base station 120 of the handover destination as continuous packets in the same session, it is necessary to cause the own-side base station to continuously recognize the SSRC identifiers, the sequence numbers and time stamps. A process for doing this is explained below.

### (SSRC Identifier)

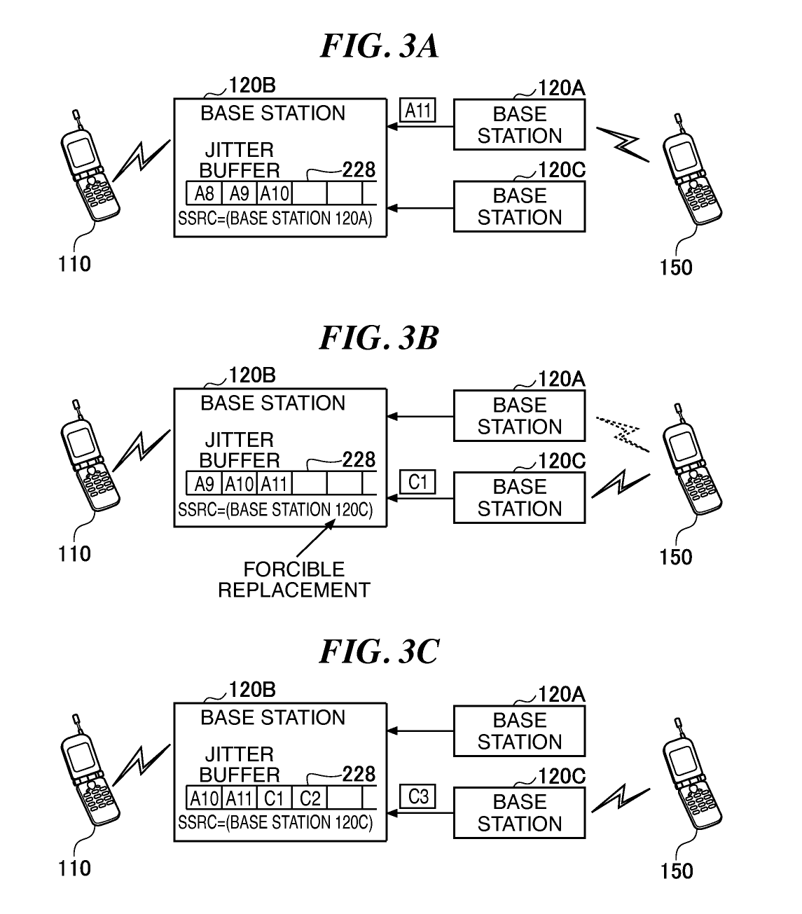

FIG. 3 is diagram for explaining the replacement of an SSRC by the continuity recognition unit 220. Here, voice data is transmitted to ones own wireless terminal 110 from the partner's wireless terminal 150 via the base stations 120A and 120B. FIG. 3A shows the state before handover and the packets (A8, A9, A10) from the base station 120A are stored in the jitter buffer 228. Then, when handover of the partner's wireless terminal 150 takes place as is shown in FIG. 3B, the base station 120B receives a new packet C1 from the base station 120C.

Then, in the base station 120B, the base station IP connection unit 206 performs an RTP process, and the continuity recognition unit 230 replaces the original SSRC with the new SSRC, which is the same as that attached to a packet from the new opponent base station 120C, in a storage region for storing the SSRC for managing a session. Therefore, the identifier matching unit 222 stores the packets from the new opponent base station 120C in the jitter buffer 228 as if it was communicating with the new opponent base station 120C so far. In this way, the packets from the original opponent base station 120A which are stored in advance are not disposed of and packets from the new opponent base station 120C are subsequently added to the jitter buffer 228 as shown in FIG. 3C.

The continuity recognition unit 230 forcibly replaces the SSRC after confirming that a packet is still coming from the same wireless terminal 150 of the communication partner in a layer bellow the session layer. If it can be confirmed that a packet is from the same wireless terminal 150, it is assumed that the data is continuous and the original and new opponent base stations are considered as if they are the same.

A termination of a session and restart of a new session are necessary in the usual switching of the opponent base station 120. In the present embodiment, however, data storage to the jitter buffer 228 is continued without terminating a session by regarding the original and new opponent base stations as the same one. In this way, it becomes possible to avoid the procedural processes which accompany a session termination and it is possible to obtain a smoother switching of the opponent base station. The present embodiment carries out a switching of the opponent base station without terminating the session, but it may terminate a session. The present embodiment may of course terminate a session, and then restart a new session with the new opponent base station 120C.

### (Sequence Number)

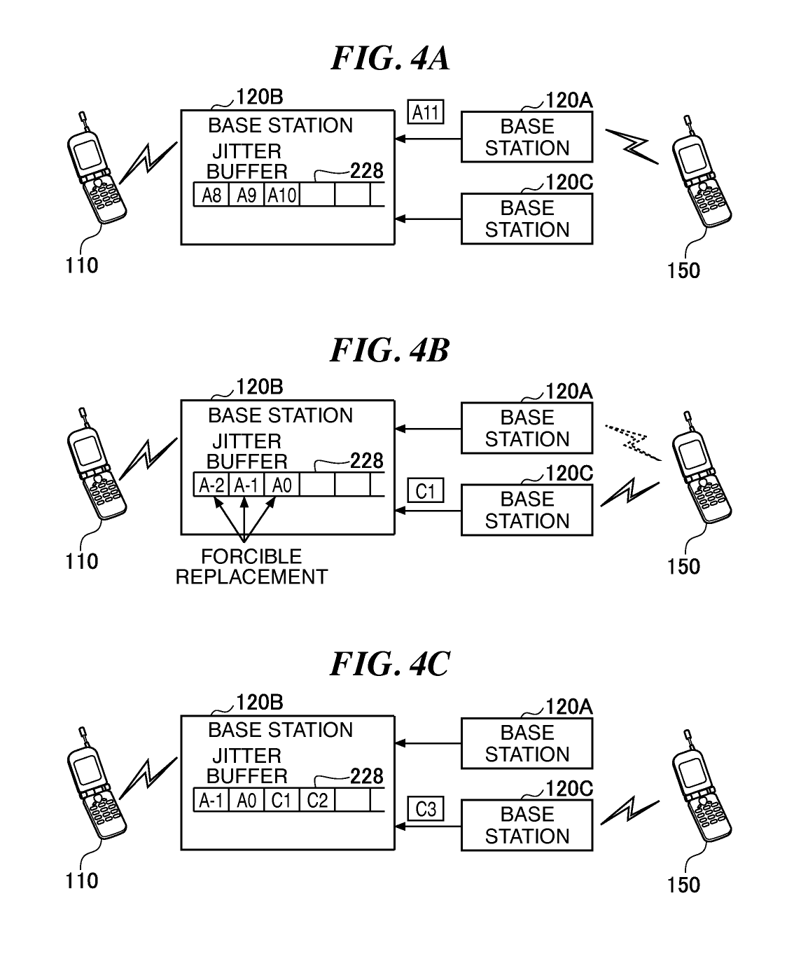

FIG. 4 is a diagram for explaining a change of sequence numbers by the continuity recognition unit 230 in the base station 120B. The numerical value attached to a character within a packet indicates a sequence number. For example, FIG. 4A shows, in a wireless communication system which uses an IP communication network, a packet of a sequence number 11 received after the packets of continuous sequence numbers 8, 9 and 10, the sequence processing unit 224 stores the packet of a sequence number 11 at the end of the jitter buffer according to that sequence number.

Then, as shown in FIG. 4B, when the packet C1 of a discontinuous sequence number is received, the continuity recognition unit 230 changes the sequence numbers of the packets from the original opponent base station already stored in the jitter buffer so that the sequence numbers of the packets from the original opponent base station and the sequence number of the packet from the new opponent base station are continuous. As a result, the packets (A9, A10, A11) already stored in the jitter buffer 228 are renumbered as packets (A-2, A-1, A-0) based on the new packet C1. In this way, the sequence numbers become continuous.

Where the sequence number of the end packet from the original opponent base station is Sₑ and the sequence number of the packet from the new opponent base station is Sₛ, the new sequence numbers of the packets already stored in the jitter buffer 228 can be decided as follows. The new sequence numbers are calculated by adding a value (Sₛ−(Sₑ+1)) respectively to the original sequence numbers of the packets from the original opponent base station. In this embodiment, 1−(11+1)=−11 is added respectively to the original sequence numbers 9, 10 and 11 of the packets (A9, A10, A11) already stored in the jitter buffer 228. So, the new sequence numbers are −2, −1 and 0.

When the new sequence numbers of the packets already in the jitter buffer 228 become continuous with that of the new packet in this way, the new packet can be stored at the end of the jitter buffer 228 as shown in FIG. 4C. Therefore, the sequence processing unit 224 can securely play back all the original data comprised of the packets reordered in their correct order.

Because the sequence numbers are used only for reordering the packets within the jitter buffer 228 in correct order, even if the sequence numbers of packets already stored are changed, there is no influence on the circuits of a latter stage.

As above, it is possible to renumber the original and new packets stored in the jitter buffer 228 so that they have continuous sequence numbers, and the following new packets with continuous numerical values can also be stored in their correct order. Therefore, it is possible to securely play back all the data in their correct order even if a packet of a random initial sequence number comes from a new opponent base station.

### (Time Stamp)

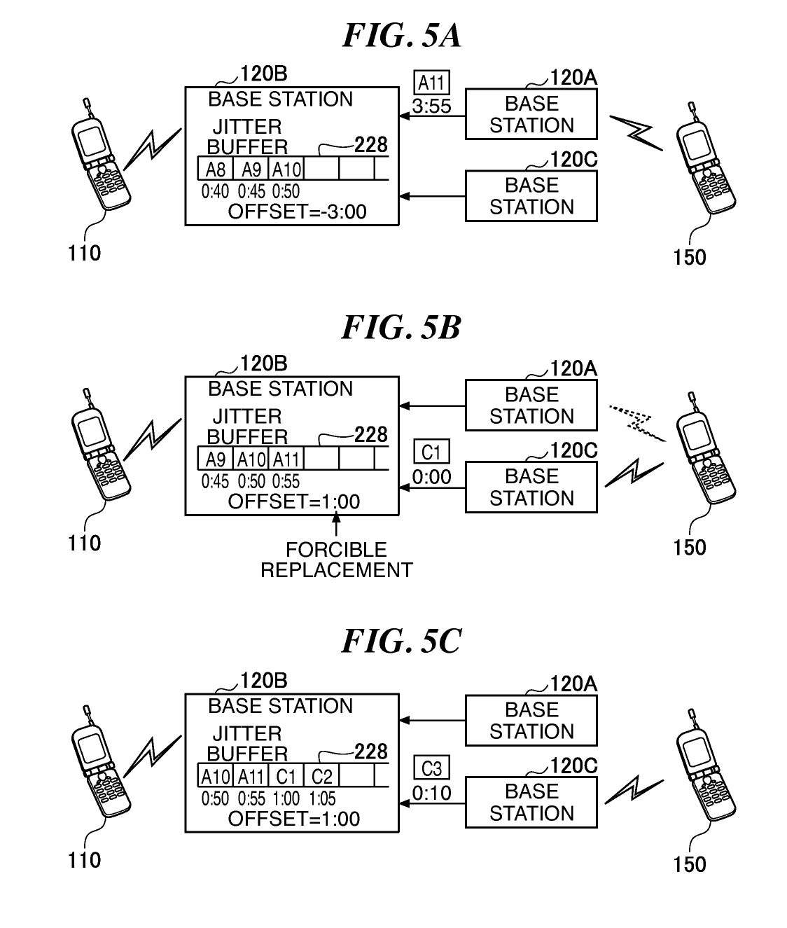

FIG. 5 is a diagram for explaining a change of time stamps by the continuity recognition unit 230. Here, the numerical values below the packets transmitted from the base stations 120A and 120C indicate time stamps. When the packets are received by the base station 120B as shown in FIG. 5A, an offset time to the amount of the initial value is added to the time stamps and playback times are generated. For example, in FIG. 5A, the offset time −3:00 is added to the time stamps 3:40, 3:45. 3:50 of the packets (A8, A9, A10) and the playback times become 0:40, 0:45, 0:50.

Then, as is shown in FIG. 5B, when a new packet C1 with a discontinuous time stamp is received, the continuity recognition unit 230 changes the offset time so that the playback times of the packets from the original opponent base station and of the new packet are continuous. Therefore, a new offset time is added respectively to the playback times of the following packets. In this way, the playback times become continuous.

The playback time Tₚ of the packets in the jitter buffer 228 is derived as Tₚ=Tₛ+T_{off}+time stamp+Tⱼ+T_{d}, where Tₛ is the start time of a session, T_{off} is the offset time, Tⱼ is the jitter assumed time and T_{d} is a fixed delay. For example, in the example in FIG. 5, Tₛ, Tⱼ, T_{d} are set to 0, and an offset time is increased in the amount of difference (+4:00) between the time stamp of the original opponent base station and the time stamp of the new opponent base station. Therefore, the new offset time becomes 1:00 and the playback time of the packet C1 becomes 1:10, as a result of adding the new offset time to the time stamp 0:00. In this embodiment, Tₛ, Tⱼ, T_{d} are set to 0 for the purposes of simple explanation, however, in an actual calculation, the playback times are adjusted by two parameters Tₛ and T_{off} and it is possible to make finer adjustments using Tⱼ, T_{d}.

In this way, when the playback times within the jitter buffer 228 become continuous as shown in FIG. 5C, it is possible to obtain the appropriate playback times of the packets and accurately play back all the data.

According to the present embodiment, it is possible to make the playback times of the original and new packets in the jitter buffer 228 continuous and also give appropriate playback times to the following packets. Therefore, it is possible to accurately play back all the data even if a packet of a random initial time stamp comes from a new opponent base station.

It is possible to obtain the order of packets from either one of the above stated time stamps and the sequence numbers. However, the sequence numbers and time stamps are required in parallel, because the order of the packets is necessary even in the case where the same time stamp data is divided by a plurality of packets.

The continuous recognition unit 230 may be adapted to start operation when a packet from the new opponent base station is first received by the packet reception unit 220. In this case, the opponent base station 120 is switched at the timing when the packet from the new opponent base station 120 is first received i.e. when the packet C1 from the base station 120C is received in FIGS. 3, 4 and 5. By recognizing the packet from the new opponent base station 120 as that from the original opponent base station 120 at this timing as stated above, it is possible to smoothly shift to the new opponent base station.

### (Wireless Communication Method)

During wireless communication between a pair of wireless terminals using the wireless terminal 110, base stations 120 and connection selection server 140 explained above, if the communication state with an original opponent base station 120 wirelessly connected so far becomes poor because the communication partner moves, communication with a new opponent base station providing a better signal state is established. In this way, switching the opponent base station i.e. a handover is carried out.

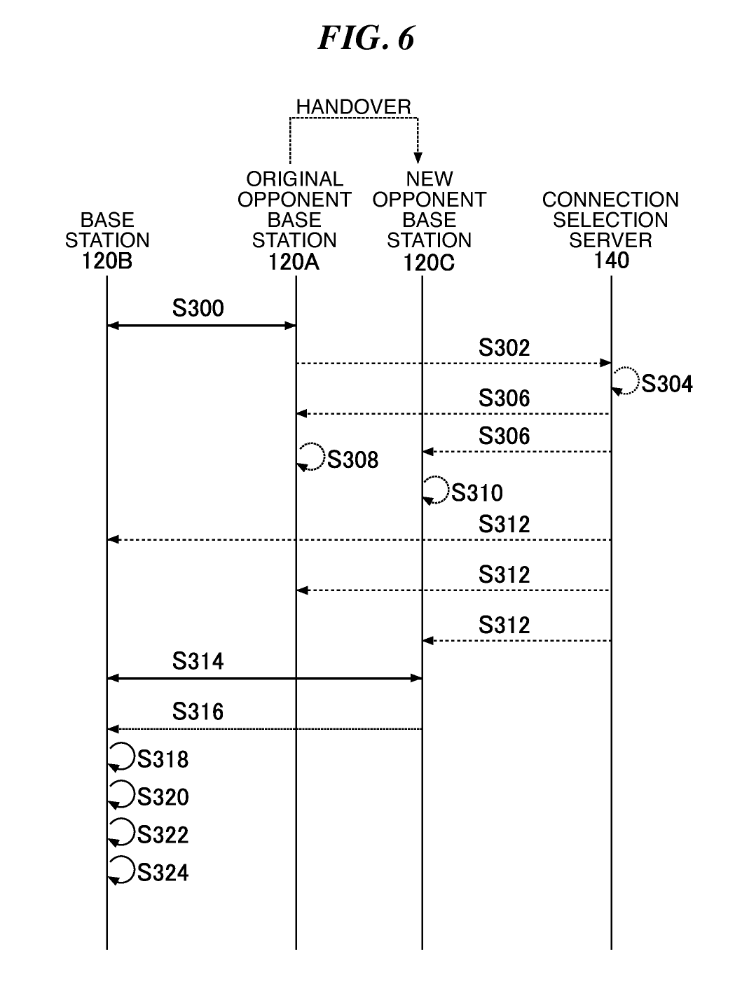

FIG. 6 is a sequence diagram which shows a process flow particularly at the time of a handover in the wireless communication system. FIG. 6 shows the initial communication state (S300) wherein the wireless terminal 110 of a user 152 and a wireless terminal of a communication partner 154 are communicated with each other via two base stations 120A and 1208.

When the communication partner 154 moves and the radio signal intensity of the wireless terminal 150 to the original opponent base station 120A becomes weak, the original opponent base station 120A requests a handover to the connection selection server 140 (S302). Then, the connection selection server 140 which receives the handover request from the original opponent base station 120A selects an appropriate new opponent base station 120C, which can communicate with the wireless terminal 150, as a destination of the handover (S304).

The connection selection server 140 transmits to the original and new opponent base station 120A and 120C information which shows that the base station 120C is selected as the new opponent base station i.e. handover destination (S306). When receiving the above information, the original opponent base station 120A begins preparations for terminating communication with the base station 1208 (S308), and the new opponent base station 120C begins preparations for establishing communication with the base station 1208 (S310). When the preparations are completed, actual handover is carried out according to the instruction of the connection selection server 140 (S312) and communication between the base station 120B and the base station 120C is established via the IP communication network 130.

When the packet reception unit 220 of the base station 120B confirms that it receives a packet from the new opponent base station 120C (S316), it causes the base station 120B to recognize packets from the original opponent base station already stored in the jitter buffer 228 and packets received from the new opponent base station after handover as continuous packets in the same session.

More specifically, the identifier correlated and set to the session is forcibly replaced with the identifier which is the same as that attached to a packet from the new opponent base station (S318), the packets from the original opponent base station already stored in the jitter buffer 228 are renumbered (S320) so that sequence numbers of the packets from the original and new opponent base stations are continuous, and an offset time is changed (S322) so that playback times of the packets from the original and new opponent base stations are continuous. Then, the new received packets are stored in the jitter buffer 228 (S324).

According to the above wireless communication method, it is possible to maintain seamless packet transmission without losing a packet using only one existing jitter buffer, even if the opponent base station is switched, as well as the wireless communication system stated above.

Although the present invention has been described with reference to the preferred embodiments while referring to the accompanying drawings, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

For example, in the embodiment described above, RTP is explained in detail as a session layer of an IP communication network. However, it is also possible to apply VoIP or other various protocols to the present embodiment.

In addition, in the embodiment described above, an explanation is given of an example whereby a base station and terminal are connected via wireless communication. However, this does not exclude connection via a fixed line. Therefore, the case where a base station and a terminal are connected via a fixed line is to be embraced within the scope of the embodiment.

Furthermore, each process in the wireless communication method of the present description does not have to be performed in a chronological order according to the order described in the flow chart. The processes may also be performed in parallel or by a subroutine.

### INDUSTRIAL APPLICATION OF THE INVENTION

The present invention can be applied to a communication device connected to devices such as a mobile phone, and in particular, the present invention can be applied to a communication device and a wireless communication method which applies a wireless communication system using a conventional Integrated Service Digital Network to an IP communication network.

What is claimed is:

1. A communication device for performing wireless communication with a wireless terminal and for being connected by a real time data transmission protocol (RTP) via an IP communication network with a plurality of opponent communication devices comprising:
a packet reception unit for receiving packets from an opponent communication device connected to said communication device;
a jitter buffer for storing the packets received by said packet reception unit; and
a continuity recognition unit for causing said communication device to recognize, when handover takes place to an original opponent communication device, that packets from the original opponent communication device stored in said jitter buffer before the handover and packets received from a new opponent communication device after the handover are continuous packets in the same session.

2. The communication device according to claim 1, further comprising:
an identifier matching unit for correlating and setting to the session an identifier which is the same as that attached to a packet from the original opponent communication device, and for matching the identifier with other identifiers of packets received by said packet reception unit;
wherein said continuity recognition unit replaces the identifier correlated and set to the session with another identifier which is the same as that attached to a packet from the new opponent communication device.

3. The communication device according to claim 1, further comprising:
a sequence processing unit for referring to sequence numbers of packets stored in said jitter buffer and of new packets received by said packet reception unit and for reordering the new packets in the order of their sequence numbers;
wherein said continuity recognition unit renumbers the packets from the original opponent communication device stored in said jitter buffer so that the sequence numbers of the packets from the original opponent communication device and of the packets from the new opponent communication device are continuous.

4. The communication device according to claim 1, further comprising:
a time conversion unit for shifting the times of time stamps of packets received by said packet reception unit to the amount of an offset time, for converting the shifted times to playback times in the session and for storing in said jitter buffer the converted playback times in connection with the packet;
wherein said continuity recognition unit changes the offset time so that the playback times of the packets from the original opponent communication device and of the received packets are continuous.

5. The communication device according to claim 1, wherein said continuity recognition unit starts operation when a packet from the new opponent communication device is first received by said packet reception unit.

6. A wireless communication method for performing wireless communication using a wireless terminal and a communication device which is connected by wireless communication with the wireless terminal and is connected by a real time data transmission protocol (RTP) via an IP communication network with opponent communication devices comprising:
a step for receiving packets from an opponent communication device connected to the communication device; and
a step for causing the communication device to recognize, when handover takes place to an original opponent communication device, that packets from the original opponent communication device stored in a jitter buffer before the handover and packets received from a new opponent communication device after the handover are continuous packets in the same session; and
a step for storing the received packets in the jitter buffer.
